(19) United States
(12) Patent Application Publication
(10) Pub. No.: US 2010/0031299 A1
(43) Pub. Date: Feb. 4, 2010

(54) SYSTEMS AND METHODS FOR DEVICE DEPENDENT MEDIA CONTENT DELIVERY IN A LOCAL AREA NETWORK

(75) Inventors: Jeffrey Paul Harrang, Sammammish, WA (US); David B. Gibbons, Redmond, WA (US)

Correspondence Address: Jeffrey Paul Harrang, Suite 2200, 1201 Third Avenue, Seattle, WA, 98101, US

(73) Assignee: OPANGA NETWORKS, LLC, Seattle, WA (US)

(21) Appl. No.: 12/534,781

(22) Filed: Aug. 3, 2009

Related U.S. Application Data
(60) Provisional application No. 61/086,101, filed on Aug. 4, 2008.

(51) Int. Cl. H04N 7/18

(52) U.S. Cl. 725/80; 725/82

(57) ABSTRACT

A media distribution system that includes a media content provider, a relay device, a data communications network, and multiple media playback devices that each have distinct device-dependent media playback capabilities. The relay device receives a media content from the media content provider over a remote portion of the data communications network, and in response to a received instruction from either the media content provider or a local media playback device, the relay device determines whether or not to reformat the received media content to be compatible with one or more media playback devices. After the reformatting determination and instruction processing, the relay device transfers the media content to designated media playback devices over a local portion of the data communications network.

### CROSS REFERENCE TO RELATED APPLICATIONS

The present application claims the benefit of U.S. Provisional Application No. 61/086,101, filed Aug. 4, 2008.

### FIELD OF THE INVENTION

The present invention generally relates to systems and methods that facilitate reformatting and/or redistribution of media content from a specialized relay device within a local area network. The relay device may be realized as a stand-alone computing device or as a component of a multi-function media playback device. The multi-function media playback device may include auxiliary components, such as digital video recorders (DVR), Blu-ray™ players, or digital video disk (DVD) player/recorder devices.

### BACKGROUND OF THE INVENTION

With the emergence of ever-improving, high-speed data communications technologies, such as fiber-optic networks and third and fourth generation (3G LTE and 4G) wireless communications, multi-media content distribution systems have been evolving at an alarming rate. Today, people are capable of accessing the same type of media content (e.g., streaming video) from their home or office, at public libraries, commercial businesses (e.g., at McDonalds® or Starbucks®), educational institutions, or while roaming, using a variety of different computing devices and communications technologies. Some of these modern computing devices, which act as media playback devices, are personal desktop computers, laptops, minicomputers, personal desktop assistant devices (PDAs) and cellular phones, cable television devices (e.g., DVRs, digital cable boxes, as well as DVD and Blu-ray™ devices), video game consoles, portable video players, electronic-book devices, home stereo units, and personal music players (e.g., MP3 and CD players, etc.). The media content accessed on these computing devices include still images (e.g., in the form of text, photographs, graphics, webpage compositions, etc.), audio, video, and audiovisual data.

Each of these specialized media playback devices has different sets of device-dependent media playback capabilities that are related to their device hardware and system installed software components. Some of these device-dependent capabilities are associated with: image resolution, image size and scale, image color depth and intensity, data compression, data encoding and decoding, data storage limits, device power settings and capacity, personalized settings, preferences and schedules, and digital rights management (DRM) support. There are several modern media distribution systems that remotely cater to some of the above media playback device capabilities by utilizing a transcoding device, embedded within a remote media server, to provide different formatted versions of the same media content to different media playback devices in accordance with their device-dependent playback capabilities.

By way of example, a remote media server or gateway device may have access to a handheld Palm® Treo™ PDA's device profile, designating an acceptable media content format (e.g., a Lo-RES display having a 160×160 1:1 aspect ratio with resolution of 25,600 pixels, or a Hi-RES display having a 320×320 1:1 aspect ratio with a resolution of 102,400 pixels). In response to a media content request, the server or gateway may take a resident 1080p formatted media content (e.g., a content having a 1920×1080 16:9 aspect ratio with a resolution of 2,073,600 pixels) and downsample and scale the 1080p media content using a transcoder to meet the Palm® Treo™ PDA's capability requirements. After the reformatting process, the server or gateway may transfer the altered media content to the compatible end user device for playback.

In this remote media delivery system, every time a user wishes to access the same media content (e.g., a purchased video content data file) for playback at a secondary media playback device, such as a Apple® PowerBook™ G4 (having a 1440×960 3:2 aspect ratio with a resolution of 1,382,400 pixels), that user needs to request that the server or gateway reformat the 1080p media content and resend the same media content to the secondary compatible end user device. Alternately, a user may request that the server or gateway resend the same media content in the original 1080p format for playback on a compatible television. Under these scenarios, limited pay-for-service bandwidth is frequently wasted by sending the same optionally reformatted media content to an end user as many times as it is requested.

Unfortunately, these modern media distribution systems fail to provide a local area network (LAN) solution for fast, dynamic distribution of locally-accessible media content. Further, none of the existing media distribution systems offer local device-dependent formatting solutions that free-up costly commercial bandwidth (pay-for-service bandwidth) by capitalizing on local network resources that provide essentially free bandwidth for data transfers. Some of these free resources may include bandwidth enabled by Wi-Fi or unshielded twisted-pair cable technologies.

As would be understood by those skilled in the art, the term “Wi-Fi” generally defines any wireless local area network (WLAN) operating in accordance with the Institute of Electrical and Electronics Engineers' (IEEE) 802.11 standards (e.g., 802.11(a), (b), and (n)). Wi-Fi is presently supported by most LAN devices, including personal desktop computers, laptops, minicomputers, PDAs and cellular phones, video game consoles and many other types of consumer home electronics. Wi-Fi Certified™ devices are typically interoperable with each other, even if they are from different manufacturers. For example, a user with a Wi-Fi Certified™ product can use any brand of access point with any other brand of client hardware that also is also Wi-Fi Certified™. For this reason, Wi-Fi communications of media content amongst LAN media playback devices is ideal for short range transfer of media content at relatively high data transfer rates.

It would be desirable for media distribution systems to reliably facilitate efficient media content delivery of correctly-formatted media content to user-designated playback devices, such that the resources required for the media content delivery and endpoint consumption are minimized. It would also be beneficial to facilitate robust access to media content stores and/or libraries from a variety of media playback devices having different communications technologies, over wide area and/or local area network portions of a broadband data communications network. Some of these communications technologies include wireline communications over optical fiber, coaxial cable, twisted-pair cable, Ethernet cable, or power-line cable; others may include wireless communications utilizing any common cellular data commutations protocol, such as GSM, UMTS, WiMAX, WiFi, or LTE protocols.

Facilitating diversified storage of the same media content would also help to improve system redundancy with respect to the reliability of media content transfers. As those skilled in the art would appreciate, in the event of catastrophic system failure (either at local or remote data repositories), it would be beneficial to have copies of important or purchased media content files at multiple and different network locations.

### SUMMARY OF THE INVENTION

In overcoming the above disadvantages associated with existing media content distribution systems, the present invention discloses a system that includes one or more media content providers (MCP), a relay device, a data communications network, and multiple media playback devices. In accordance with one aspect of the present invention, the relay device receives media content from a MCP over a first portion of the data communications network. In response to a received instruction, the relay device then determines whether to reformat the received media content to be compatible with one or more media playback devices.

In accordance with another aspect of the invention, the relay device distributes the received media content to a media content compatible media playback device over a second portion of the data communications network, in response to the received instruction.

In accordance with a further aspect of the invention, the first portion of the data communications network is a wide area network (WAN) and the second portion of the data communications network is a local area network (LAN).

In accordance with another aspect of the invention, the relay device is further configured to reformat the received media content to be compatible with both a first media playback device having a first media playback characteristic and a second media playback device having a second media playback characteristic.

In accordance with yet another aspect of the invention, the first media playback characteristic is a video resolution that is compatible with the first media playback device and the second media playback characteristic is a different video resolution that is compatible with the second media playback device.

In accordance with a further aspect of the invention, the MCP formats and distributes a first portion of the media content to a selected media playback device over the first portion of the data communications network and then the relay device distributes a second portion of the media content to the selected media playback device over a second portion of the data communications network

In accordance with another aspect of the invention, a computer-readable medium is encoded with computer executable instructions, which when executed, perform a method including receiving at a relay device, a media content from a media content provider (MCP) over a first portion of a data communications network, and determining whether to reformat the received media content to be compatible with at least one of a plurality of media playback devices, in response to a received instruction.

In accordance with yet a further aspect of the invention, is a relay device for formatting media content within a local area network (LAN), the relay device includes one or more processors, one or more memories, a transcoder, and one or more transceivers. A relay device transceiver receives media content from a remote computing device, and a relay device processor executes a received instruction and then determines whether to utilize the transcoder to reformat the media content to be compatible with a specified media playback device within the LAN.

In accordance with yet another aspect of the invention, the transcoder reformats the received media content and the at least one transceiver transmits the reformatted media content to the specified media playback device, in response to the processor-executed instruction.

### DESCRIPTION OF THE DRAWINGS

Preferred and alternative examples of the present invention are described in detail below with reference to the following Figure drawings:

FIG. 1 illustrates a perspective view of a distributed media content delivery system in accordance with an embodiment of the present invention;

FIG. 2 illustrates a block diagram of a media content provider in accordance with an embodiment of the present invention;

FIG. 3 illustrates a block diagram of a LAN relay device in accordance with an embodiment of the present invention;

FIG. 4 illustrates a flow diagram of a user registration and device synchronization process in accordance with an embodiment of the present invention;

FIG. 5 illustrates a flow diagram of a general media content distribution process in accordance with an embodiment of the present invention;

FIG. 6 illustrates a flow diagram of a local media content distribution process in accordance with an embodiment of the present invention;

FIG. 7 illustrates a flow diagram of a remote media content distribution process an embodiment of the present invention;

FIG. 8 illustrates a user profile interface webpage in accordance with an embodiment of the present invention;

FIG. 9 illustrates a device profile interface webpage in accordance with an embodiment of the present invention;

FIG. 10 illustrates a media catalog interface in accordance with an embodiment of the present invention; and

FIG. 11 illustrates a user library interface in accordance with an embodiment of the present invention.

### DETAILED DESCRIPTION

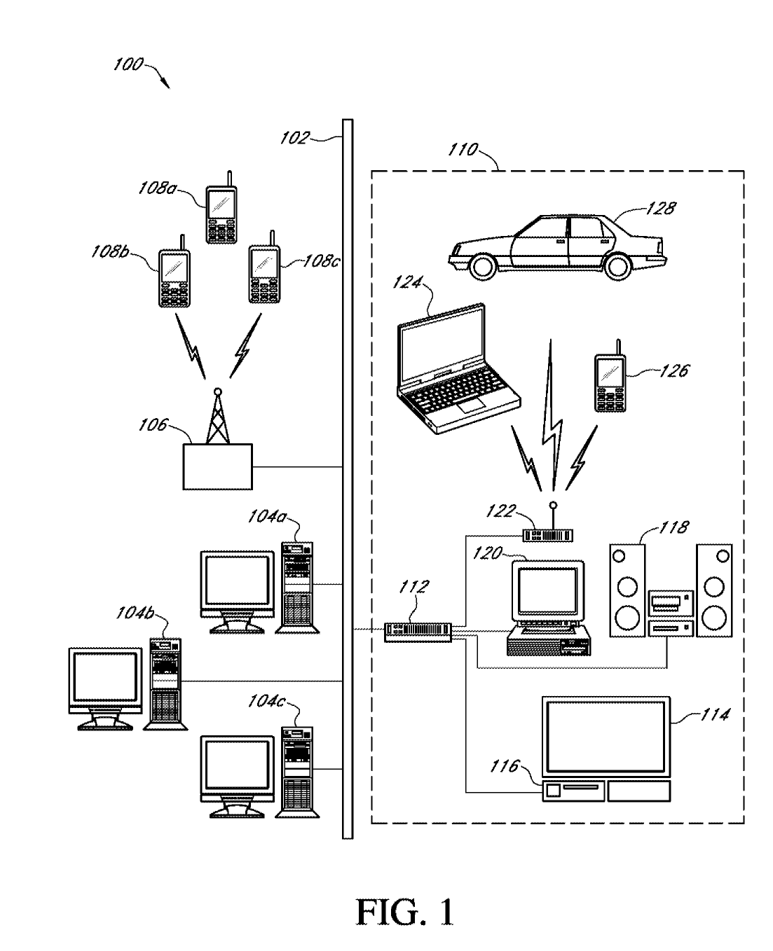

In accordance with an exemplary embodiment of the present invention, FIG. 1 illustrates a distributed computing system 100 including various wireline and wireless computing devices that may be utilized to implement any of the device-dependent media content delivery service processes associated with various embodiments of the present invention. The distributed computing system 100 may include, but is not limited to, a group of remote server devices 104a-c, any one of which may be associated with a Media Content Provider (MCP) that can provide media distribution services to various networked clientele; a communications network 102 (hereafter, also referred to as a WAN); one or more remote client devices 108a-c that may be connected to the communications network 102 utilizing a wireless basestation 106 or any common cable network technology; one or more network relay devices 112 that can facilitate various media content distribution processes within the LAN 110; a television device 114 (e.g., a high-definition LCD or Plasma television) that is connected to a multi-function media playback device 116, which may include various specialized components, such as: a relay device (similar to relay device 112), a digital video recorders (DVR), Blu-ray™ players, and digital video disk (DVD) player/recorder devices; a home stereo unit 118; a personal desktop computer 120; a wireless router 122 that may communicate with various wireless LAN 110 devices using any common local wireless communications technology, such as Wi-Fi or unshielded twisted pair cable; a wireless laptop computer 124; a personal digital assistant (PDA) device 126; and an automobile 128 having wireless communications technology and optionally various media playback devices (e.g., seatback video player devices, not shown).

In an embodiment, the relay device 112 may also include local routing functionality to facilitate data communications amongst LAN 110 connected devices, including: the television device 114, the multi-function media playback device 116, the home stereo unit 118, the personal computer 120, the wireless router 122, the laptop computer 124, the PDA device 126, and the automobile 128. In accordance an embodiment, the relay device 112 may also act as a local gateway device, connecting the WAN 102 to the LAN 110. Those skilled in the art would realize that gateway devices are generally responsible for maintaining data communications between various network portions and the World Wide Web. In an alternate embodiment, the relay device 112 may be replaced by a simple network router or switch and the relay device functionality may be embedded within the multi-function media playback device 116. In this embodiment, the multi-function media playback device 116 would facilitate data communications amongst the LAN 110 connected devices 114, 116, 118, 120, 122, 124, and 126.

In an embodiment, the remote server devices 104a-c, the wireless basestation 106, the remote client devices 108a-c, and any of the LAN 110 connected devices 112, 114, 116, 118, 120, 122, 124, and 126, may be configured to run any known operating system, including but not limited to, Microsoft Windows™, Mac OS™, Linux™, Unix™, or any common mobile operating system, including Symbian™, Palm™, Windows Mobile™, Mobile Linux™, MXI™, etc. In an embodiment, the remote server devices 104a-c, the wireless basestation 106 as well as any of the remote client devices 108a-c may employ any number of common server, desktop, laptop, and personal computing devices. In an embodiment, the remote client devices 108a-c and any of the LAN 110 connected devices 114, 116, 118, 120, 122, 124, and 126 may include any combination of mobile computing devices (e.g., cellular phones, PDAs, eBooks, ultra-portable computers, personal music players, etc.), having wireless communications capabilities utilizing any common cellular data commutations protocol, such as GSM, UMTS, WiMAX, Wi-Fi, or LTE protocols. In one particular embodiment the LAN 110 connected devices 114, 116, 118, 120, 122, 124, and 126 may communicate amongst each other and with the relay device 112 using a local Wi-Fi enabled communications network. In this embodiment, all of the LAN 110 connected devices 114, 116, 118, 120, 122, 124, and 126; including the relay device 112 may be Wi-Fi Certified™ devices.

In an embodiment, the WAN 102 may include, but is not limited to, any of the following communications technologies: optical fiber, coaxial cable, twisted pair cable, Ethernet cable, power-line cable, and any microwave point-to-point technology known in the art. In an embodiment, any of the remote server devices 104a-c, the wireless basestation 106, the remote client devices 108a-c, and any of the LAN 110 connected devices 112, 114, 116, 118, 120, 122, 124, and 126, may include any standard computing software and hardware necessary for processing, storing, and communicating data amongst each other within the distributed computing system 100. The computing hardware may include, but is not limited to, one or more processors, volatile and non-volatile memories, user interfaces, transcoders, and wireline and/or wireless communications transceivers.

In an embodiment, a remote server device 104a-c and the relay device 112 (alternately the optional relay device embedded within the multi-function media playback device 116) may be configured to include a computer-readable medium (e.g., any common volatile or non-volatile memory type) encoded with a set of computer-readable instructions, which when executed, performs one or more control and/or data transfer functions associated with any of the device-dependent media content delivery processes of the present invention.

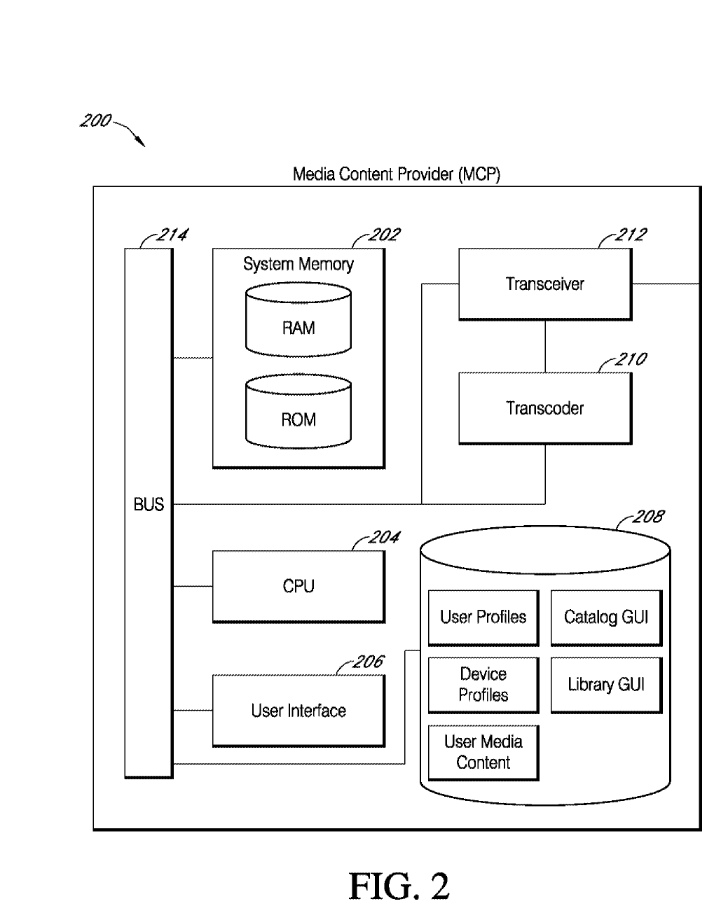

FIG. 2 shows a block diagram view of a media content provider (MCP) server device 200 that may be representative of any of the remote server devices 104a-c in FIG. 1. The MCP server 200 may include, but is not limited to, one or more processor devices including a central processing unit (CPU) 204. In an embodiment, the CPU 204 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 204 is primarily responsible for executing all computer programs stored on the MCP server device's 200 volatile (RAM) and nonvolatile (ROM) system memories 202. The MCP server 200 may also include: a user interface 206 that allows a server administrator to have access to the server's resources; a content database 208 that includes repositories for user profiles, device profiles, user media content, as well as storage for media catalog and media library graphical user interfaces (GUIs); a transcoder 210 for formatting media content, and a transceiver 212 for transmitting and receiving data over the WAN 102 and the LAN 110 of FIG. 1.

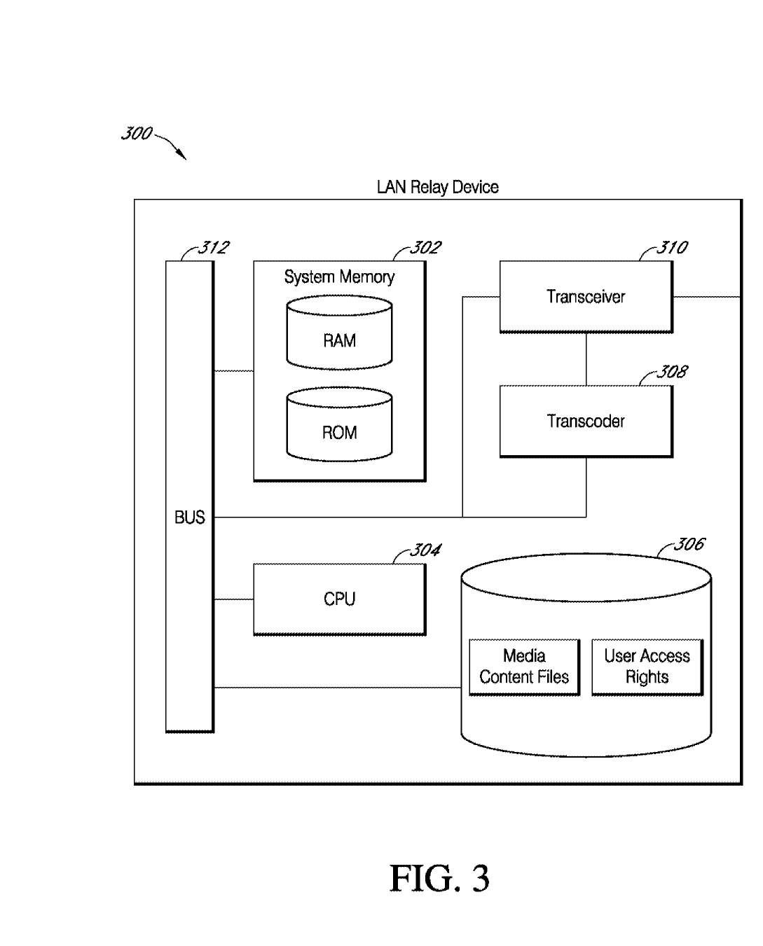

FIG. 3 shows a block diagram view of a LAN relay device 300 that may be representative of either the relay device 112 or the multi-function media playback device 116 (having an embedded relay device component) in FIG. 1. The relay device 300 may include, but is not limited to, one or more processor devices including a central processing unit (CPU) 304 that is primarily responsible for executing all computer programs stored on the relay device's 300 volatile (RAM) and nonvolatile (ROM) system memories 302; a media content database 306 that includes repositories for downloaded media content files, and sets of user access rights that permit certain users to access specified media content within the media content files; a transcoder 308 for formatting a media content; and one or more transceivers 310 for transmitting and receiving data within the LAN 110 and across the WAN 102 of FIG. 1.

It should be understood that transcoding, as discussed in the present application, is generally directed to digital-to-digital conversion from one encoding format to another. It is usually performed on incompatible media content in order to transform the media content into a more suitable format for proper display or output at an end user device (e.g., display in accordance with a receiving device's capabilities). Some of these device-dependent capabilities are associated with: image resolution, image size and scale, image color depth and intensity, data compression, data encoding and decoding, data storage limits, device power settings and capacity, personalized settings, preferences and schedules, and digital rights management (DRM) support. In an embodiment, a transceiver (212 or 310) is a device having both a transmitter and a receiver that share common circuitry or a single housing. In another embodiment, transmitter and receiver components (not shown) of the transceiver (212 or 310) may not share common circuitry between transmit and receive functions. In an embodiment, the transcoder (212 or 310) is a device that is capable of formatting media content files from one digital format to another without substantially undergoing a complete decoding and encoding process. This may be possible if the source device and the target device have similar codecs.

However, in accordance with another embodiment, complete decoding and encoding between dissimilar data formats may be supported by the transcoder device 210 or 308. As would be understood by those skilled in the art, one popular method of transcoding media data is to decode an original data to an intermediate data format (e.g., pulse code modulation (PCM) for audio or YUV color space for video), in a way that still substantially contains the original data content, and then encoding the intermediate data into a target device's data format.

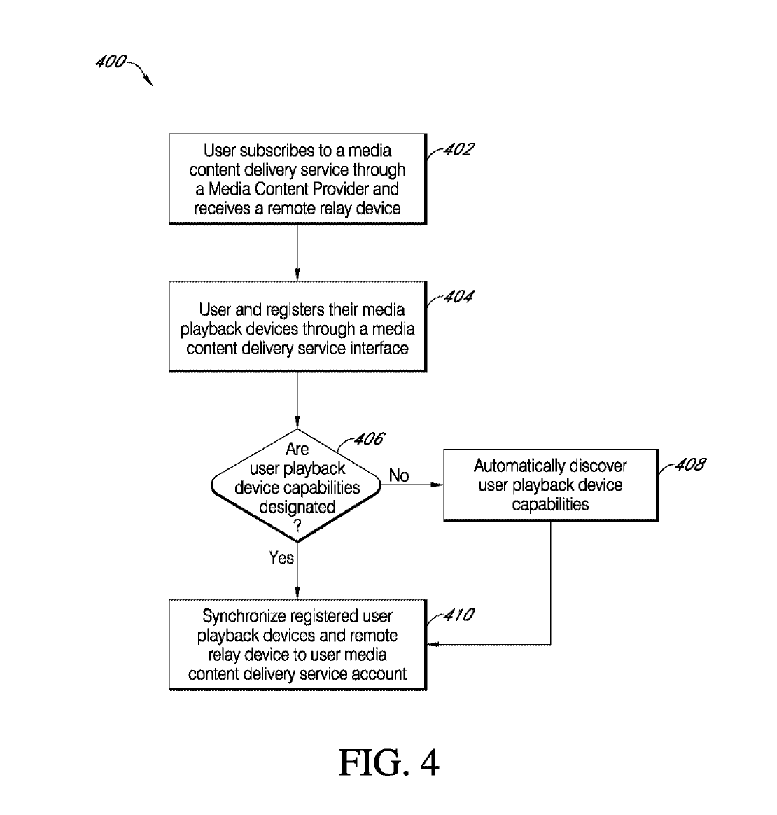

FIG. 4 illustrates a flow diagram of a user registration and device synchronization process 400 in accordance with an embodiment of the present invention. It should be understood that this process 400 could be executed using one or more computer-executable programs stored on one or more computer-readable mediums located on either the MCP server 200 or the relay device 300 (or an agent device working with the relay device 300 within the LAN 110). At block 402 a user may subscribe to a media content delivery service through a MCP server 200. The user will generally receive a remote relay device 112 with their subscription, which they can add into there LAN 110. In an alternate embodiment, a user may already possess a relay device that is capable of communicating with and receiving instruction from a MCP server 200. Next at block 404, the user may register each of their media playback devices (e.g., any of the television device 114, the multi-function media playback device 116, the home stereo unit 118, the personal desktop computer 120, the wireless laptop computer 124, the digital assistant (PDA) device 126, or the automobile 128 having seatback video player devices of FIG. 1) through a media content delivery interface, such that both the MCP server 200 and the relay device 300 will recognize every possible target destination device. Further, at decision block 406 it is determined if a user has designated the registered media playback devices' capabilities. If not, at block 408, the user's media content playback devices may be automatically discovered by either the MCP server 200 or the relay device 300, by sending an optional information gathering request to the registered media playback devices to directly determine their device capabilities information, or their manufacturer and model code/electronic serial number. Some of these device-dependent capabilities are associated with: image resolution, image size and scale, image color depth and intensity, data compression, data encoding and decoding, data storage limits, device power settings and capacity, personalized settings, preferences and schedules, and digital rights management (DRM) support. In the later case, compatibility information may be determined by looking up a playback device's capabilities (e.g., by referencing a manufacturer and device model or electronic serial number) in a device compatibility lookup table online at a website over the Internet). Alternately, a playback device's capabilities can be or approximated by assigning a generic capabilities profile or a same-manufacturer capabilities profile to a particular media playback device. Once all of a user's playback devices' capabilities are determined, then at block 410, the user's registered playback devices and relay device will be synchronized with a user's media content delivery service account at the MCP server 200. This device synchronization process allows the server to keep an up-to-date record of a user's LAN media device assets.

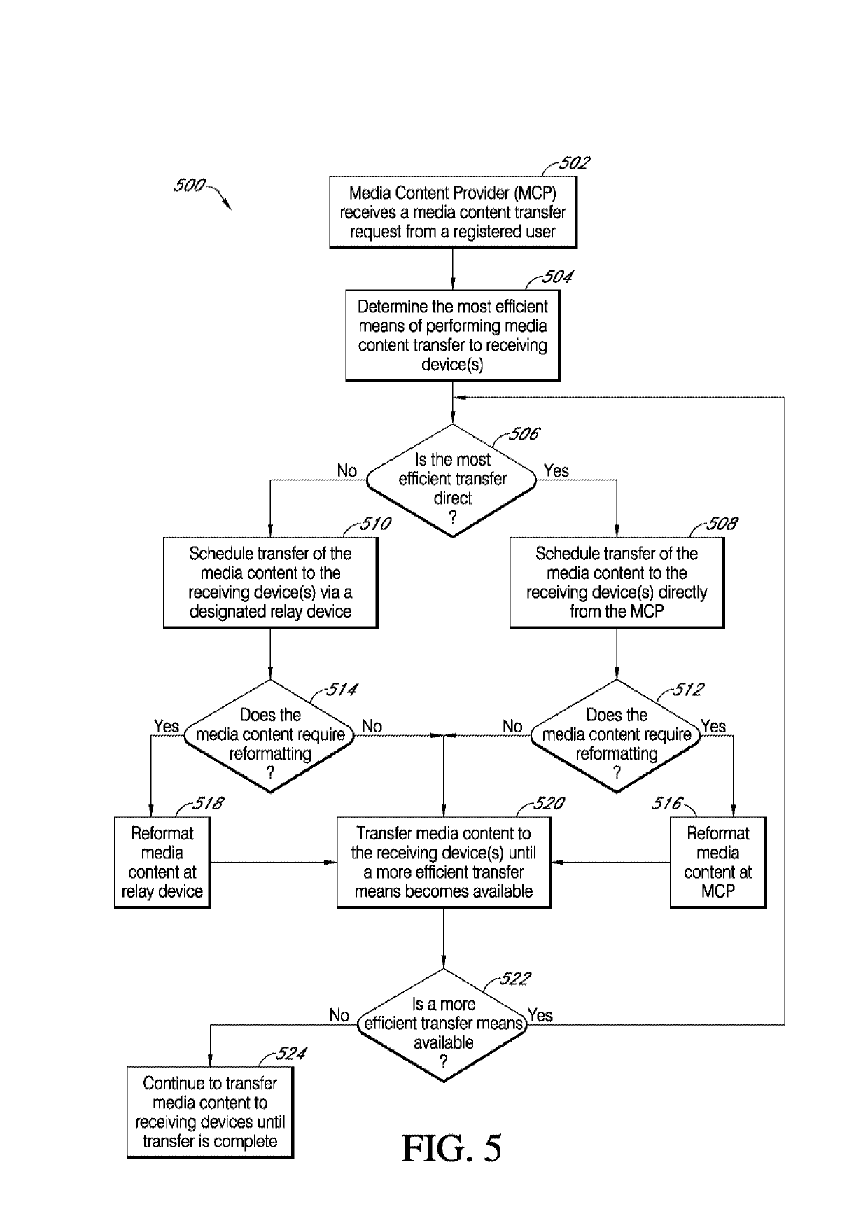

FIG. 5 illustrates a flow diagram of a media content distribution process 500 in accordance with an embodiment of the present invention. It should be understood that this process 500 could be executed using one or more computer-executable programs stored on one or more computer-readable mediums located on either the MCP server 200 or the relay device 300. At block 502, a MCP server 200 receives a media content transfer request from a registered user of a media content provider service. Then at block 504, the MCP server 200 or a relay device 300 having a copy of the requested media content, determines the most efficient means of performing the media content transfer to one or more of user's designated receiving devices (e.g., any of the television device 114, the multi-function media playback device 116, the home stereo unit 118, the personal desktop computer 120, the wireless laptop computer 124, the digital assistant (PDA) device 126, or the automobile 128 having seatback video player devices of FIG. 1). At decision block 506 it is then determined if the most efficient means for media content transfer is direct. If it is determined that the most efficient transfer means is direct, at block 508, a transfer of the requested media content to the designated target receiving device(s) is scheduled with the MCP server 200 as the source of the media content transfer. However, if it is determined that the most efficient transfer means is not direct, at block 510, a transfer of the requested media content to the designated target receiving device(s) is scheduled with the relay device 300 as the source of the media content transfer. Assuming a direct transfer was designated, at decision block 512 it is then determined if the media content request requires reformatting the media content. If it does, at block 516, the MCP server 200 reformats the media content to be compatible with the designated receiving device(s). Conversely, assuming an indirect transfer was designated, at decision block 514 it is determined if the media content request requires reformatting the media content. If it does, at block 518, the relay device 300 reformats the media content to be compatible with the designated receiving device(s). After ensuring the media content is compatible with the target receiving devices, at block 520, the media content is transferred to connected (connected either to the MCP 200 or the relay device 300) receiving devices until a more efficient means of transfer becomes available or a present means of transfer is terminated. Next, at decision block 522 it is determined if a more efficient transfer means is available. If there is a more efficient transfer means available, the process returns to decision block 506, and the subsequent decision block steps are repeated. However, if there is not a more efficient transfer means, at block 524, the current transfer from either the MCP server 200 or the relay device 300 to the target receiving devices resume until the media content transfer is complete and the media is ready for playback at each of the receiving devices.

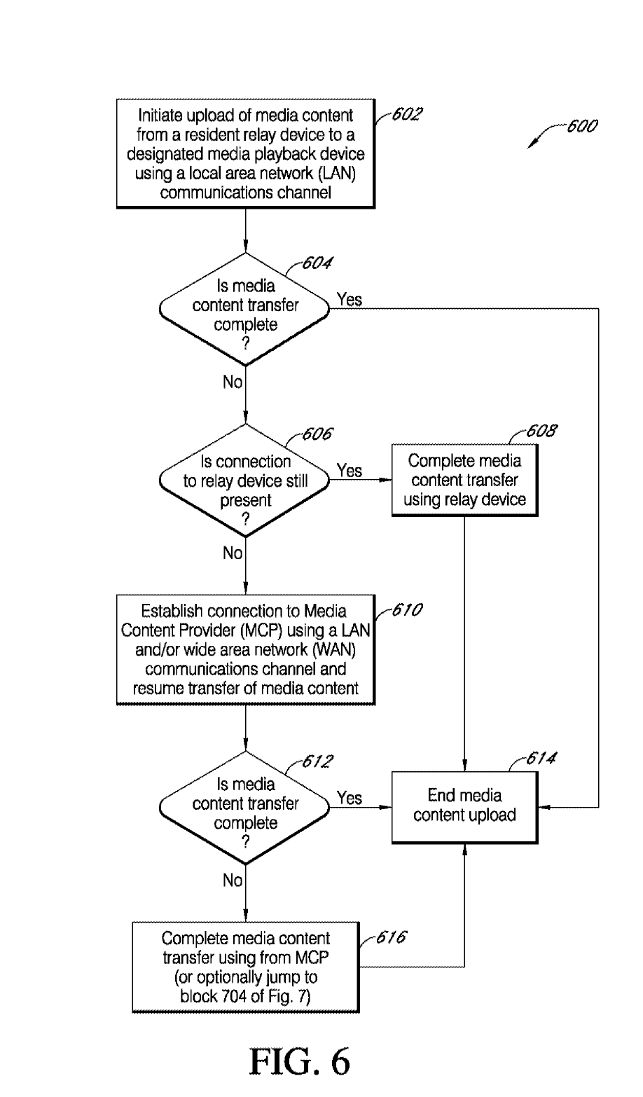

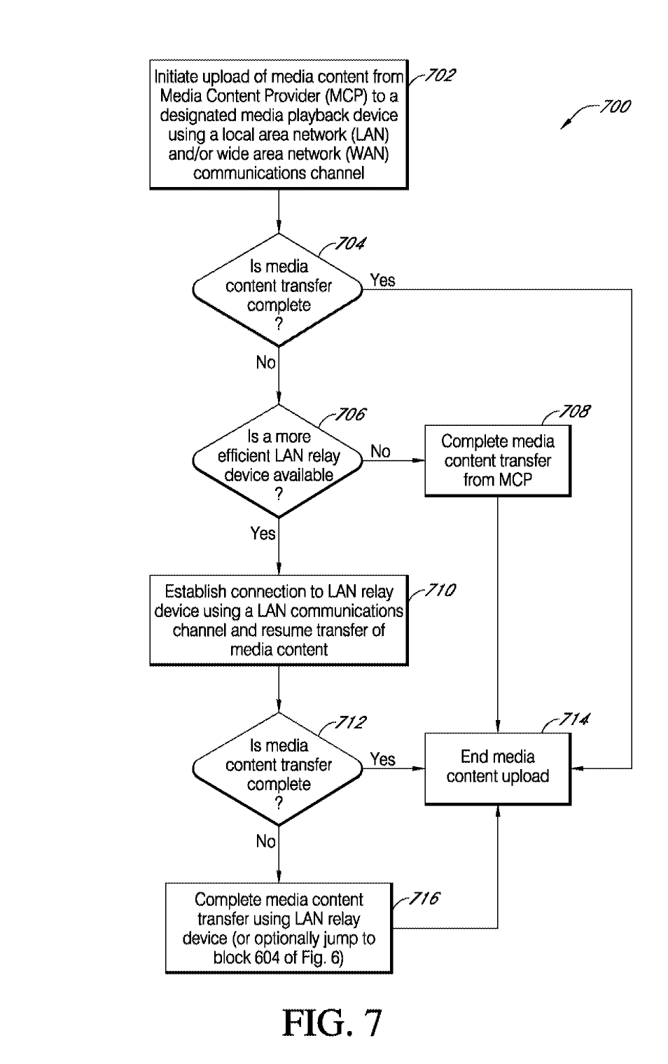

FIG. 6 illustrates a flow diagram of locally initiated media content distribution process 600 in accordance with an embodiment of the present invention. It should be understood that this process 600 could be executed using one or more computer executable programs stored on one or more computer-readable mediums located on either the MCP server 200 or the relay device 300. At block 602, a media content upload is initiated from a resident relay device 300 to a designated media playback device using a LAN 110 communications channel. Next, at decision block 604, it is determined if the media content transfer is complete. If the transfer is complete, the process proceeds to block 614, and the associated media content upload is ended. If the transfer is not complete, the process proceeds to decision block 606 where it is determined if the relay device 300 uploading the media content is still connected to the designated media playback device. If the connection is still present, the process proceeds to block 608 where media content transfer is completed from the relay device 300 and then the process ends at block 614. If it is determined that the relay device 300 is not connected to the designated media playback device (e.g., when the media content is located beyond a relay device Wi-Fi communications range) a connection to the MCP 200 is established using an available LAN 110 and/or a WAN 102 communications channel (e.g., a WiMAX or cellular network). Then at decision block 612, it is again determined if the media content transfer is complete. If the transfer is complete, then the media content upload ends at block 614. However, if the media content transfer is not complete, the media content transfer is completed from the MCP 200 and the media content transfer is ended at block 614. Optionally, in the case where the connection to the MCP is terminated, and the media content transfer is still incomplete, the upload will attempt to resume from a detected LAN 110 (by jumping to block 704 of FIG. 7, discussed further herein).

FIG. 7 illustrates a flow diagram of a remotely initiated media content distribution process 700 in accordance with an embodiment of the present invention. It should be understood that this process 700 could be executed using one or more computer executable programs stored on one or more computer-readable mediums located on either the MCP server 200 or the relay device 300. At block 702, a media content upload is initiated from a MCP server 200 to a designated media playback device using a LAN 110 and/or a WAN 102 communications channel. Next, at decision block 704, it is determined if the media content transfer is complete. If the transfer is complete, the process proceeds to block 714 and the associated media content upload is ended. If the transfer is not complete, the process proceeds to decision block 706 where it is determined if a more efficient LAN relay device 300 is available. If a more efficient local solution is not present, the process proceeds to block 708 where media content transfer is completed from the MCP server 200 and then the upload process ends at block 714. If it is determined that a more efficient LAN relay device 300 is available, at block 710, a connection is established to the relay device 300 using a LAN communications channel 110 and transfer of the media content is resumed. Then at decision block 712, it is again determined if the media content transfer is complete. If the transfer is complete, then the media content upload ends at block 714. However, if the media content transfer is not complete, the media content transfer is completed from the relay device 300 and the media content transfer is ended at block 714. Optionally, in the case where the connection to the relay device 300 is terminated, and the media content transfer is still incomplete, the upload will attempt to resume from a detected MCP server 200 (by jumping to block 604 of FIG. 6, supra).

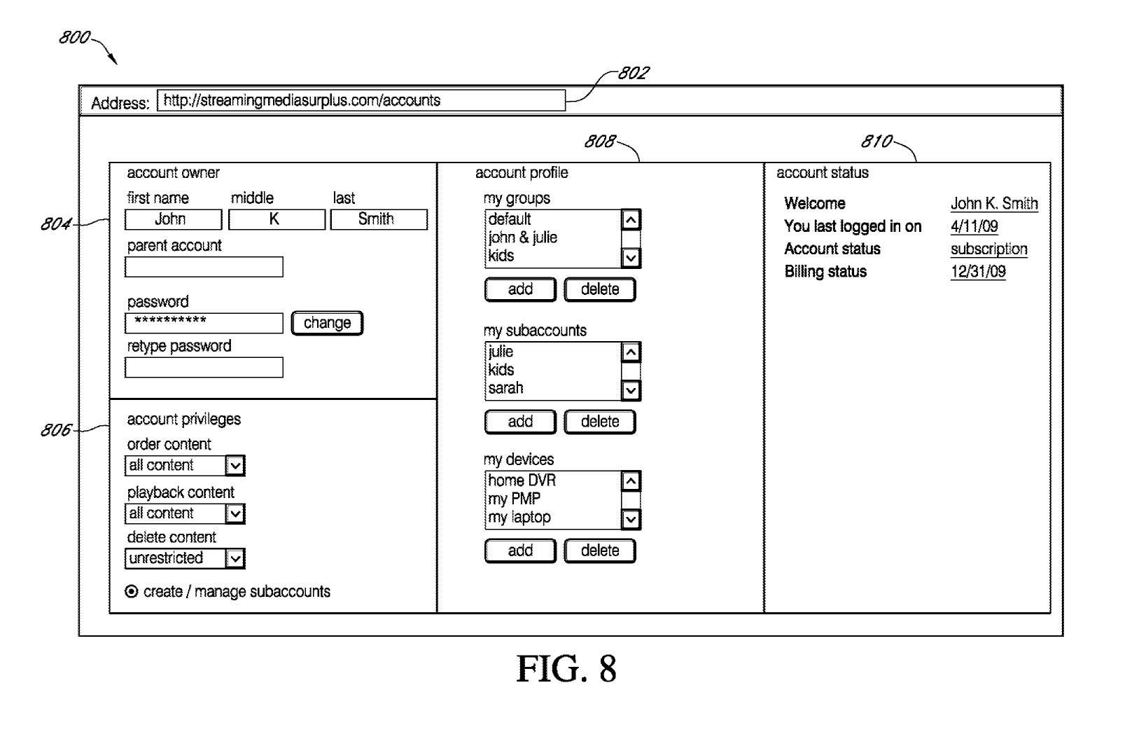

FIG. 8 illustrates a user profile interface webpage 800 in accordance with an embodiment of the present invention. The user profile interface webpage 800 could exist on any of the remote server devices 104a-c, any one of which may be associated with an MCP 200 server. In an embodiment, the streaming media surplus website is an online MCP offering various media content (including moving pictures) for download to subscribed users. The user profile interface webpage or “accounts” webpage 800 includes, but is not limited to, a URL address bar 802 having an HTTP address for the webpage's 800 location on the Internet (http://streamingmediasurplus.com/jksmith/devices), an account owner's section 804, an account privileges section 806, an account profile 808 section, and an account status section 810. In an embodiment, the account owner's section 804 may have a name field where a user register their name, an optional parent account field, and a password information field; the account privileges section 806 may have an order content selection field, a playback content selection field, and a delete content selection field; the account profile section 808 may have a user groups listing, a subaccounts listing, and a my devices listing; and the account status section 810 may include a welcome notice, a most recent login notice, an account status notice, and a billing cycle notice.

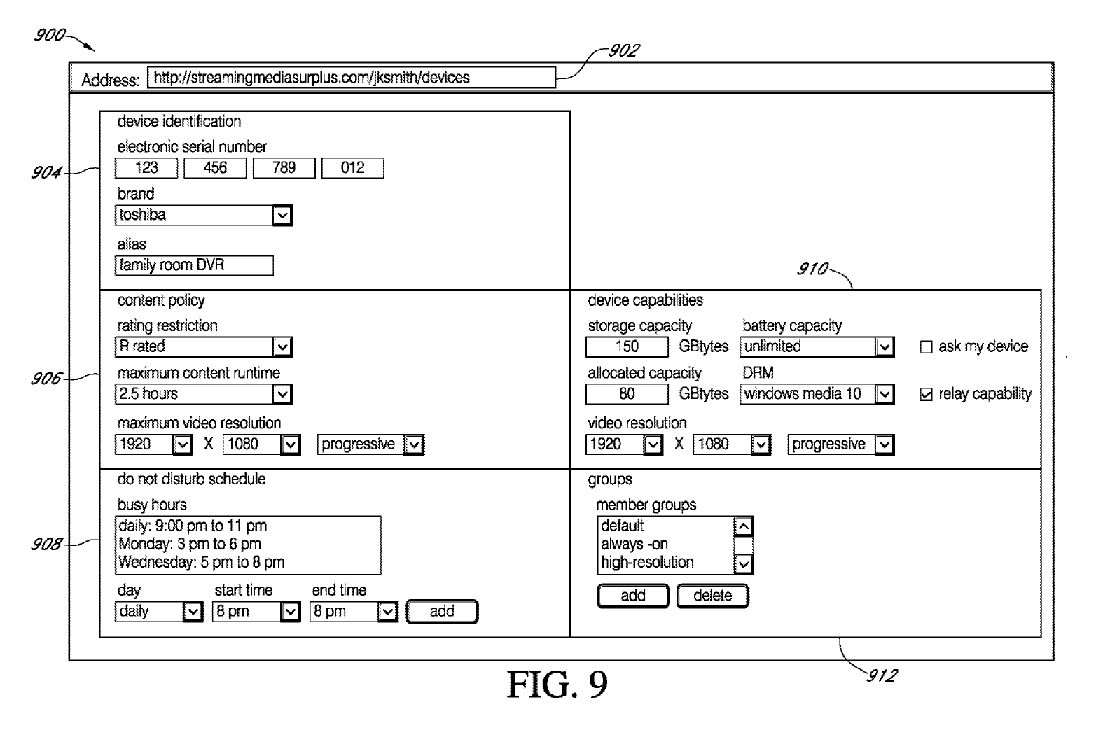

FIG. 9 illustrates a user device profile interface webpage 900 in accordance with an embodiment of the present invention. The user device profile interface webpage 900 could exist on any of the remote server devices 104a-c, any one of which may be associated with an MCP 200 server. The user device profile interface webpage or “devices” webpage 900 includes, but is not limited to, a URL address bar 902 having an HTTP address for the webpage's location on the Internet (http://streamingmediasurplus.com/jksmith/devices), a device identification section 904, a content policy section 906, a do not disturb schedule 908 section, a device capabilities section 910, and a member groups section 912. In an embodiment, the device identification section 904 may have an electronic serial number field where a user register their device, device brand selection field, and a password information field; the account privileges section 906 may have an order content selection field, a playback content selection field, and a delete content selection field; the account profile section 908 may have a user groups listing, a subaccounts listing, and a my devices listing; and the account status section 910 may include a welcome notice, a most recent login notice, an account status notice, and a billing cycle notice.

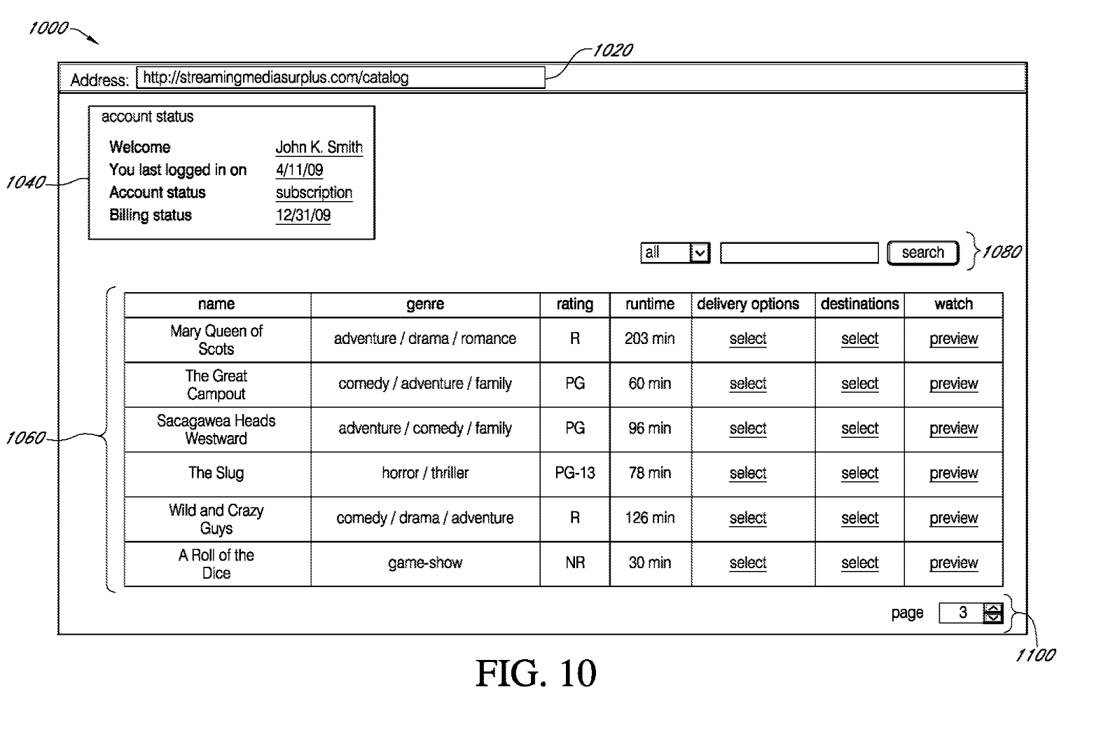

FIG. 10 illustrates a MCP catalog interface webpage 1000 in accordance with an embodiment of the present invention. The MCP catalog interface webpage 1000 could exist on any of the remote server devices 104a-c, any one of which may be associated with an MCP 200 server. The MCP catalog interface webpage or “catalog” webpage 1000 includes, but is not limited to, a URL address bar 1120 having an HTTP address for the webpage's location on the Internet (http://streamingmediasurplus.com/catalog), a user account status section 1040, a movie catalog selection section 1060, a catalog search field 1080, and a catalog page selection component 1100. In an embodiment, the account status section 1040 may include a welcome notice, a most recent login notice, an account status notice, and a billing cycle notice. In an embodiment, the movie catalog selection section 1060 may include a listing of available movies resident in the MCP server's 200 content database 208 (including a plurality of movies of different genres: “Mary Queen of Scots”, “The Great Campout”, “Sacagawea Heads Westward”, “The Slug”, “Wild and Crazy Guys”, and “A Roll of the Dice”). From the movie catalog selection section 1060 a registered user is capable of ordering a movie to their account and designating delivery options as well as delivery destinations, and previewing portions of the movies to determine if they wish to purchase entire movie content file. In an embodiment, the catalog search field 1080 allows a user to search for a particular movie within the catalog by entering information such as a title name, a genre plus a portion of a title name, a headlining actor or actress, a year of release, or any other common searchable information related to a media content. In an embodiment, the catalog page selection component 1100 may allow a user to scroll through media alphabetically or in order from a top-down listing of returned search results.

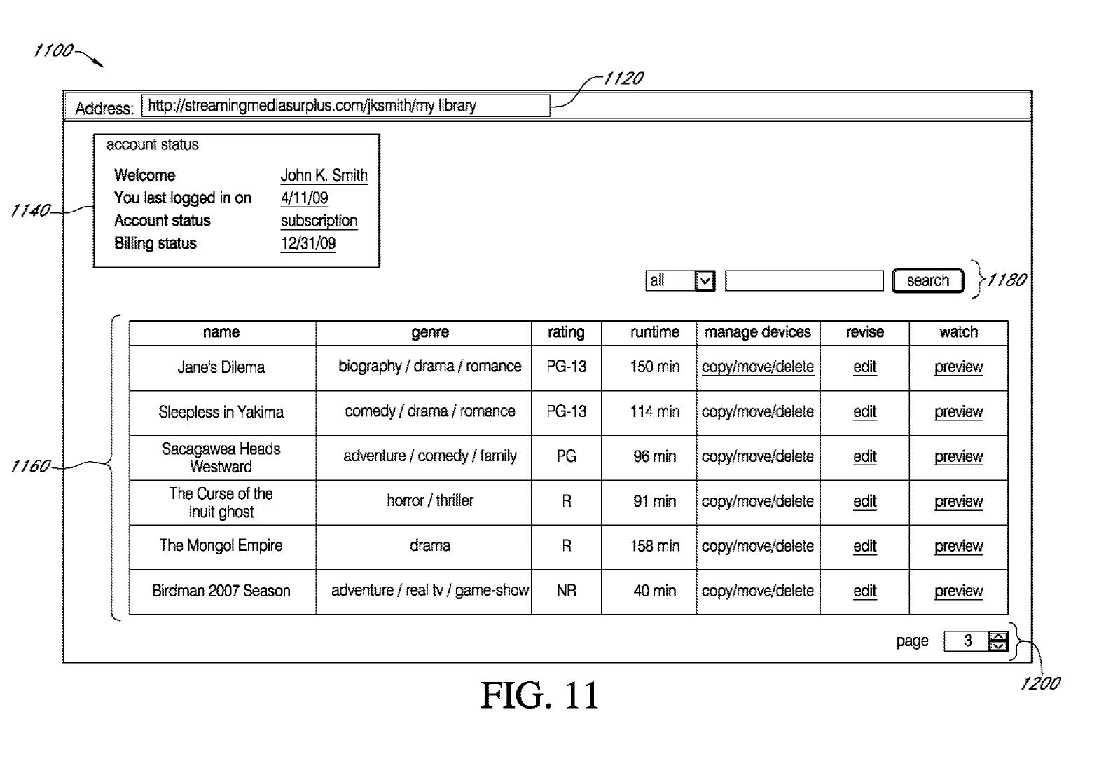

FIG. 11 illustrates a user's media library interface webpage 1100 in accordance with an embodiment of the present invention. The user's media library interface webpage 1100 could exist on any of the remote server devices 104a-c (any one of which may be associated with an MCP 200 server) or the relay device 300. The user's media library interface webpage or “library” webpage 1100 includes, but is not limited to, a URL address bar 1120 having an HTTP address for the webpage's location on the Internet (http://streamingmediasurplus.com/jksmith/mylibrary), a user account status section 1140, a movie library management section 1160, a library search field 1180, and a catalog page selection component 1200. In an embodiment, the account status section 1140 may include a welcome notice, a most recent login notice, an account status notice, and a billing cycle notice. In an embodiment, the movie library management section 1160 may include a listing of movies resident in the MCP server's 200 content database 208 or the relay device's 300 media content database 306 (including a plurality of movies of different genres: “Jane's Dilema”, “Sleepless in Yakima”, “Sacagawea Heads Westward”, “The Curse of the Inuit Ghost”, “The Mongol Empire”, and “Birdman 2007 Season”). From the user's media library interface webpage 1100 a registered user is capable of managing their media content library by copying, moving, editing, and deleting media content files on and between user devices and designated playback device profiles, and previewing portions of the movies to determine if they wish to watch or modify them for playback. In an embodiment, the library search field 1180 allows a user to search for a particular movie within the library by entering information such as a title name, a genre plus a portion of a title name, a headlining actor or actress, a year of release, or any other common searchable information related to a media content. In an embodiment, the library page selection component 1200 may allow a user to scroll through media alphabetically or in order from a top-down listing of returned search results.

In an embodiment, online delivery of media content files may occur utilizing one or more MCP servers 104a-c, whenever a download target media playback device (e.g., any of the television device 114, the multi-function media playback device 116, the home stereo unit 118, the personal desktop computer 120, the wireless laptop computer 124, the digital assistant (PDA) device 126, or the automobile 128 having seatback video player devices of FIG. 1) is connected to a MCP server 200 via a broadband network, such as the WAN 102 and/or LAN 110 of FIG. 1. The MCP server 200 can maintain configuration state information concerning the playback device's capabilities such as: image resolution, image size and scale, image color depth and intensity, data compression, data encoding and decoding, data storage limits, device power settings and capacity, personalized settings, preferences and schedules, and digital rights management (DRM) support. Whenever a media playback device shares connection to a LAN 110 with a relay device 112, it may automatically rendezvous with the relay device 300 and determine if there is ordered media content locally present that can be reformatted (if necessary) for the playback device. If there is, the media content may be delivered to the playback device after optionally reformatting for the device's playback capabilities. When the media playback device is roaming away from a LAN 110 (e.g. a mobile cellular phone, PDA, or laptop), but attached to a broadband WAN 102, it may continue to receive media content from one or more remote MCP servers 104a-c. Under this scenario, the media playback device may continue to receive online media content that is correctly formatted in accordance with its capabilities, wherever it may be located. Users of media playback devices may interact with a user interface (e.g., with the user interfaces shown in FIGS. 8 and 9) provided by a MCP 200 to create and manage device and user profiles. The online store keeps state information concerning user and device profiles, and the user's selected media content in a personal media library.

In an embodiment, the present invention has two phases of operation: media content acquisition and management, and media content delivery. In the acquisition phase, a user may interact with a MCP 200 directly utilizing a web browser or indirectly via a relay device 300 interface having various user services managed by the MCP server 200. In the media content delivery phase, the MCP 200 routes orders for selected media content to content delivery servers (e.g., any of remote servers 104a-c), which in turn process the orders and deliver the associated media content to the target media playback devices. In an embodiment, the MCP server 200 may directly deliver media content to a target media playback device, or the MCP 200 may employ one or more content delivery agents to indirectly deliver a media content based on a particular network's architecture.

In the media content acquisitions and management phase of operation, a registered user may log into an MCP 200 using a web browser (e.g., Microsoft® Internet Explorer™ or Mozilla® Firefox™) running on their local computing device (e.g., their PDA 126 communicating through both local 110 and wide area 102 networks). The user can establish an account or accesses a previously established account with the MCP 200 using their personal computing device. Account information may be stored in a user profile associated with a user's authentication credentials (e.g., a profile generated with through the user profile interface webpage 800). In an embodiment, a user profile information may include, but is not limited to: user authentication credentials (e.g. username/password), account privileges (e.g. ability to create/managed sub-accounts, access to certain types of media content, ability to order content, ability to delete content from a library), groups (e.g. user IDs or group IDs of other users that share their libraries with this user—family members, friends, etc.), device profile, account access statistics (e.g. time last logged in, log-in failures), and account status (e.g. billing status, subscription type).

A device profile associated with the user's profile is a list of the user's media playback devices that can access the user's personal media content library and the device's capabilities and policy settings. Information stored in the device profile (See e.g., user device profile interface webpage 900 content) can include, but is not limited to: video resolution (e.g. supported video modes and screen dimensions), compressed audio/video decoders (e.g. supported audio and video types), mass storage limits (e.g. maximum, allocated), battery capacity (e.g. maximum playback time), do-not-disturb schedule (e.g. when device should not be receiving content), DRM support (e.g. supported DRM protocols), category (e.g. name of the group of associated devices—“default”, “mobile”, “automobile”, “home”, etc.), overwrite policy (e.g. never overwrite, overwrite oldest files first, overwrite previously viewed only), and content restriction policy (e.g. maximum playback time, maximum video resolution, allowed content ratings). In an embodiment, users can either supply device capability data for their devices, if known, or request that the online store and user device connect so the online store can query the device's capabilities. This may happen whenever the device contacts the online store based on the device's unique ID (e.g. electronic serial number).

In an embodiment, a user of a MCP 200 may utilize a common web browser (e.g., Microsoft® Internet Explorer™ or Mozilla® Firefox™) to select deliverable media content from the MCP catalog interface webpage 1000 maintained by the MCP server 200. The user can select one or more media content files and designate the target device(s) to which the file will be delivered (e.g., any of the television device 114, the multi-function media playback device 116, the home stereo unit 118, the personal desktop computer 120, the wireless laptop computer 124, the digital assistant (PDA) device 126, or the automobile 128 having seatback video player devices of FIG. 1). In an embodiment, the MCP 200 can maintain a media content database which stores the titles of media content files that are stored on a user's various media playback devices. To view and manage their personal media content library database, the user accesses a MCP server's 200 media library interface webpage 1100. In an embodiment, a user can manage their media content files with operations including, but not limited to, file deletion and file transfer (e.g. making a file available on another user device). Once the media content files are delivered to the target playback devices the personal media library database is periodically updated with a user's media playback devices, whenever a playback device is online and can contact the MCP server 200 (e.g., using an automated script).

In the media content delivery phase of operation, the MCP server 200 can pass media content delivery requests that select designated media content files to be delivered to target media playback devices (e.g., any of the television device 114, the multi-function media playback device 116, the home stereo unit 118, the personal desktop computer 120, the wireless laptop computer 124, the digital assistant (PDA) device 126, or the automobile 128 having seatback video player devices of FIG. 1). In an embodiment, a media content order specifies the target media playback devices and their device profiles in order for the media content delivery servers 104a-c to select an appropriately formatted file for delivery. A user's collection of media playback devices may include mobile devices such as laptops 124 and portable media players, as well as fixed devices such as home theater DVRs 116. Mobile devices 124, 126, and 128 may be collocated with fixed devices 114, 116, 118, and 120 when sharing a LAN 110, or roaming and attached to various types of wireless access networks (e.g., roaming wireless network provided by basestation 106). Typically, fixed devices are associated with larger higher-definition media content files (e.g., 1080p data for Plasma and LCD televisions 114) and also have greater processing and storage capabilities, and support for more types of protocols. Fixed devices are also normally ‘always on’ meaning they are always connected to the outside network 102 and remote media content delivery servers 104a-c.

When a mobile media playback device is roaming, media content delivery servers 104a-c may transfer media content directly to the playback device in the appropriate format based on the device-dependent capabilities profile. In an embodiment, when a mobile device 124, 126, and 128 is collocated (attached to the same LAN 110) with a fixed device having relay device function (an optional relay device embedded within the multi-function media playback device 116) for delivering media content to the mobile device. The purpose of the relay device is to avoid having to send multiple copies of the same media content file in different playback formats over the WAN 102 between the MCP 200 and/or media content delivery servers 104a-c and the media playback devices, in cases where media content files for a device can be produced locally by the relay device (e.g., 112 or 116). A fixed device acting as a relay 116 is assumed to have a media content file resident either in the target playback device's preferred format or in a format from which the preferred format can be produced (e.g., transcoding from a higher definition video format to an equivalent or lower definition video format). In an embodiment, whenever a mobile device is resident on a LAN 110 it will listen for relay services being advertised by the relay device 112. In an embodiment, when a mobile device discovers a relay device 112 can run an automated script to determine if the relay device 112 has any media content files that the mobile device needs, based on the requests a user has placed for the mobile device. If there are, the mobile device downloads the appropriate portions of the file directly from the relay device 112. If there are not, the mobile device can download the media content file from the MCP server 200 or associated remote media content delivery servers 104a-c.

In an embodiment, when a relay device 112 needs to reformat a media content file that is encrypted for example with digital rights management (DRM) content protection protocols, and a decryption key is not locally available (e.g. in the relay device's local license store), the relay device 112 may obtain an unencrypted copy of the media content file before it can reformat a video or audio content. There are several ways a relay device 112 can proceed depending on the DRM configuration of the media content file.

In an embodiment, if a DRM requires a real-time creation of the decryption key at playback time, then the relay device 110 can be provisioned with the user's DRM account credentials (e.g. username/password) and the relay device 110 can run a remote license-server proxy session to obtain the decryption key, decrypt the file, reformat the media content, optionally re-encrypt the reformatted media content, and transfer the media content and decryption key to the authenticated requesting target playback device.

In an embodiment, if a media content is delivered with DRM authorization rights to pre-fetch the decryption key prior to playback, the relay device may first fetch the decryption key (e.g. by establishing a session with a remote license server) before following a similar sequence to the first described case of delivering media content to the requesting target playback device. This case is nearly identical to the first case but differs in that other credentials (e.g., authorization code) may be supplied with the relay device's 112 encrypted media content file in order to successfully negotiate a remote license server exchange and decrypt the media content file. If the media content is delivered along with a pre-authorized decryption key, the relay device 112 may first decrypt the media content file using the supplied key before following a similar sequence to the first described case of delivering media content to the requesting target playback device.

In cases where the relay device 112 must re-encrypt a reformatted local media content file, delivery to the target media playback device must be completed while the device is connected to the relay device 112. This is because the MCP 200 and/or remote content delivery servers 104a-c do not have access to relay's private keys used to re-encrypt the reformatted media content file and cannot deliver a partial media content file while the target device is roaming. Ordinarily this is not an issue since LAN 110 media content transfer rates are typically 10-100 times better than WAN 102 wireless access links 106. However, in the case where a target media playback device has started but not completed transferring a media content file from a local relay device 112, and is abruptly removed from the LAN 110, then either the target playback device must reattach to the LAN 110 to receive the remaining portions of the media content file, or the target device must receive the entire file from the MCP 200 and/or the remote content delivery servers 104a-c while roaming and out of contact with the relay device 112. Alternatively, the target device might continue to receive content from the relay device 112 while roaming, if peer-to-peer media delivery is supported.

In accordance with various embodiments of the present invention, various restrictions on operation are assumed to exist. Additionally, there are some basic requirements and assumptions that must be maintained in order for device-dependent delivery to function. These operational assumptions may include the following: the media content to be delivered from the MCP server 200 must be available in a format that is appropriate for the target media playback device; a relay device 300 must have access to content to be delivered either in a format suitable for the target media playback device, or in a format suitable for reformatting for the target media playback device; a relay device 300 must be capable of reformatting local media content files needed for the target media playback device in cases where reformatting is required; the MCP server 200 must be capable of maintaining state information for user and device profiles; the MCP server 200 must be capable of maintaining state information for a user's personal media library; and whenever online with the MCP server 200, media playback devices must be able to periodically upload the state of their local content storage.

In accordance with various embodiments of the invention, the following operational scenarios are facilitated by aspects of the present invention:

In accordance with a first scenario, a user subscribes to a media content delivery service through a MCP server 200 interface 800 that will allow the user to create and maintain a personal library of media content files 1100. A particular user may have several media playback devices, each with onboard storage for media content files, including a home theater DVR 116, a portable media player 128, a PDA cell phone 126, and a laptop 124. The user logs into a MCP server 200 using an ordinary web browser to set up their account and order content 800. The user registers each of their media playback devices and selects the DVR 116 and the laptop 124 as the default destination media playback devices (the choices can be managed over time) 900. While registering devices the user provides information about the type of device and its media handling capabilities or, if unknown, the user can click a link that will launch a web service to query the user's device and auto-discover its capabilities.

The user then browses a large catalog of media files via a web browser GUI 1000 and selects a group of media content files. Each of the files may be delivered to a default device group that the user has selected 912. For a few of the files (e.g. television episodes), the user clicks on a “select destinations” link 1060 that allows the user to further specify delivery to their portable media player 128 and PDA cell phone 126. The MCP server 200 delivers the media content to the devices and each device receives the content in a format consistent with its capabilities. Over time, the user builds up a personal library of media content files distributed across their media playback devices. The user periodically logs into the MCP server 200 to browse and manage their personal media library of delivered content 1100. Media content files can be marked for deletion or addition on a per-device basis. The user's devices periodically synchronize with the online store so that the user's personal media library may be kept up to date. In the case of more than one user sharing a personal library of content files the scenario is similar. A user is the parent of family and is the online store administrator for their account. The user administrator can establish multiple sub-accounts 808 each with selectable privileges for managing content across the user's playback devices. Each sub-account user logs onto the MCP server 200 and can manage the media content library 1100 according to their account privileges.

In accordance with a second scenario, a user is interested in a television series and has ordered the entire season's set of episodes. The user selects and begins watching the first episode from their home content library stored on their home DVR 116 in multi-channel audio and HD format on a large home theater flat panel. The following day, the user commutes to work and while waiting for a train, uses a small screen PDA 126 with a mono-audio Bluetooth earphone to watch another episode. Later on a business trip the user accesses the same content using a medium resolution laptop 124 displays and stereo audio. Although the sizes of the content files and playback formats are different in each case, the user can access their content library wherever they go and on whatever media playback device they use.

In accordance with a third scenario, a user orders a large number of online content files to be delivered over time to their content library. While their portable media player devices are at user's home they receive content that is delivered via the user's broadband Internet service (e.g. cable, DSL). When the user leaves on a family vacation trip with his laptop 124, the laptop continues to receive content via the user's broadband wireless service (e.g. 3G, WiMAX, 106) whenever the laptop is turned on. Later in the hotel, the laptop 124 is again connected online via the hotel's WiFi network and content continues to be delivered. The media content library continually grows and the user sees more and more media content files appearing in their library. When the user returns home, the user's home DVR 116 has already finished receiving the entire content delivery order (since it has access to an always-on high-capacity broadband service) whereas the laptop 124 is still working on the delivery order (since it has been only intermittently connected over a variety of wireless networks). The DVR 116 quickly serves the remaining content in the order to the laptop 124 over the users home LAN 110.

In accordance with a fourth scenario, a user orders a number of online media content files to be delivered and indicates that some of the files should be delivered to both their home DVR 116 and the user's automobile 128. While in the garage, the automobile 128 receives media content downloaded to the DVR 116 (in HD format) and reformatted for the small screen playback system in the automobile 128 before being relayed to the automobile's 128 onboard media content storage unit via WiFi. While driving, the automobile 128 continues to receive content via the user's broadband wireless service (e.g. 3G, WiMAX) or whenever the automobile 128 is in range of a public WiFi network.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed: are defined as follows:

1. A media distribution system comprising:
at least one media content provider (MCP);
a relay device;
a data communications network; and
a plurality of media media playback devices,
wherein the relay device receives a media content from the at least one MCP over a first portion of the data communications network, and in response to a received instruction, the relay device determines whether to reformat the received media content to be compatible with at least one of the plurality of media playback devices.

2. The media distribution system of claim 1, wherein in response to the received instruction, the relay device distributes the received media content to a media content compatible media playback device over a second portion of the data communications network.

3. The media distribution system of claim 2, wherein the first portion of the data communications network is a wide area network (WAN) and the second portion of the data communications network is a local area network (LAN).

4. The media distribution system of claim 1, wherein the relay device is further configured to reformat the received media content to be compatible with both a first media playback device having a first media playback characteristic and a second media playback device having a second media playback characteristic.

5. The media distribution system of claim 4, wherein the first media playback characteristic is a video resolution that is compatible with the first media playback device and the second media playback characteristic is a different video resolution that is compatible with the second media playback device.

6. The media distribution system of claim 1, wherein the at least one MCP formats and distributes a first portion of the media content to a selected media playback device over the first portion of the data communications network and then the relay device distributes a second portion of the media content to the selected media playback device over a second portion of the data communications network.

7. A computer-readable medium encoded with computer executable instructions, which when executed, perform a method comprising:
receiving at a relay device, a media content from a media content provider (MCP) over a first portion of a data communications network; and
determining whether to reformat the received media content to be compatible with at least one of a plurality of media playback devices, in response to a received instruction.

8. The computer-readable medium of claim 7, wherein the method further comprises distributing the reformatted media content to a media content compatible media playback device over a second portion of the data communications network.

9. The computer-readable medium of claim 8, wherein the first portion of the data communications network is a wide area network (WAN) and the second portion of the data communications network is a local area network (LAN).

10. The computer-readable medium of claim 7, wherein the method further comprises reformatting the received media content to be compatible with both a first media playback device having a first media playback characteristic and a second media playback device having a second media playback characteristic.

11. The computer-readable medium of claim 10, wherein the first media playback characteristic is a video resolution that is compatible with the first media playback device and the second media playback characteristic is a different video resolution that is compatible with the second media playback device.

12. The computer-readable medium of claim 7, further comprising formatting and distributing a first portion of the media content to a selected media playback device over the first portion of the data communications network using the MCP and then distributing a second portion of the media content to the selected media playback device over a second portion of the data communications network with the relay device.

13. A computer-implemented method comprising:
receiving at a relay device, a media content from a media content provider (MCP) over a first portion of a data communications network; and
determining whether to reformat the received media content to be compatible with at least one of a plurality of media playback devices, in response to a received instruction.

14. The computer-implemented method of claim 13, wherein the method further comprises distributing the reformatted media content to a media content compatible media playback device over a second portion of the data communications network.

15. The computer-implemented method of claim 14, wherein the first portion of the data communications network is a wide area network (WAN) and the second portion of the data communications network is a local area network (LAN).

16. The computer-implemented method of claim 13, wherein the method further comprises reformatting the received media content to be compatible with both a first media playback device having a first media playback characteristic and a second media playback device having a second media playback characteristic.

17. The computer-implemented method of claim 16, wherein the first media playback characteristic is a video resolution that is compatible with the first media playback device and the second media playback characteristic is a different video resolution that is compatible with the second media playback device.

18. The computer-implemented method of claim 13, further comprising formatting and distributing a first portion of the media content to a selected media playback device over the first portion of the data communications network using the MCP and then distributing a second portion of the media content to the selected media playback device over a second portion of the data communications network with the relay device.

19. A relay device for formatting media content within a local area network (LAN), the relay device comprising:
at least one processor;
at least one memory;
a transcoder; and
at least one transceiver, wherein
the at least one transceiver receives a media content from a remote computing device; and
the at least one processor executes a received instruction and then determines whether to utilize the transcoder to reformat the media content to be compatible with a specified media playback device within the LAN.

20. The relay device of claim 19, wherein in response to the processor-executed instruction, the transcoder reformats the received media content and the at least one transceiver transmits the reformatted media content to the specified media playback device.
